(19) United States
(12) Patent Application Publication
(10) Pub. No.: US 2016/0018828 A1
(43) Pub. Date: Jan. 21, 2016

(54) PRESSURE-BASED MASS FLOW CONTROLLER WITH REVERSE FLOW MODE FOR FAST BLEED DOWN

(71) Applicants: Daniel T. MUDD, Reno, NV (US); Patti J MUDD, Reno, NV (US)

(72) Inventors: Daniel T. MUDD, Reno, NV (US); Patti J MUDD, Reno, NV (US)

(21) Appl. No.: 14/700,125

(22) Filed: Apr. 29, 2015

Related U.S. Application Data
(60) Provisional application No. 61/996,146, filed on Apr. 29, 2014.

(51) Int. Cl. G05D 7/06; G05B 15/02

(52) U.S. Cl. CPC G05D 7/0629; G05B 15/02

(57) ABSTRACT

A gas delivery apparatus to overcome the shortcomings of the prior art by evacuating process gas upstream of a pressurized volume with a reverse flow mode.

### CROSS-REFERENCE TO RELATED APPLICATIONS

This application claims the benefit of priority under 35 U.S.C. 119(e) to U.S. Application No. 61/996,146, filed Apr. 29, 2014, entitled DEVICES, MECHANISMS AND ALGORITHMS TO ADDRESS THE SLOW BLEED DOWN RESPONSE ISSUE SEEN IN PRESSURE BASED FLOW CONTROL DEVICES, by Daniel T. Mudd et al., the contents of which are hereby incorporated by reference in its entirety.

### FIELD OF THE INVENTION

The invention relates generally to semiconductor processing, and more specifically, a pressure-based flor mass flow controller with reverse flow mode for fast bleed down.

### BACKGROUND OF THE INVENTION

Mass flow controllers (MFCs) and electronic regulators are important components of delivering process gasses (e.g., N2, O2, SF6, C4F8 . . . etc.) for semiconductor fabrication. MFCs are normally used to turn on, turn off, and control process gas flows at a desired flow rate.

However, commercially available MFCs are slow to transition between gases or to transition between from higher flow rates of a single gas. Of particular interest are low flow rate MFCs which utilized a pressurized volume to generate a desired low flow rate. When process gas the pressurize volume needs to be reduced (e.g., for lower flow rates) or evacuated (e.g., for changing to a new type of process gas), the conventional bleed down process occurring at or downstream from the pressurized volume.

Therefore, what is needed is a robust technique in gas delivery apparatus to overcome the shortcomings of the prior art by evacuating process gas upstream of a pressurized volume with a reverse flow mode.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 includes block diagrams illustrating abstract views of components involved in a forward flow mode and in a reverse flow mode, according to an embodiment.

### DETAILED DESCRIPTION

The disclosure provides gas delivery apparatus, gas delivery methods, non-transitory source code for reversing gas flow from an accumulated volume to a non-process location for faster pressure regulation with when going to lower pressures. For example, a semiconductor process receiving nitrogen gas at a certain mass flow rate can require a reduction in flow rate.

For pressure based MFC's and other related flow/pressure control devices, where the proportional control valve is upstream of a flow restrictor a pressure drop across the restrictor results when there is flow through the restrictor. The mass stored in the volume(s) between the two, i.e.: the P1 volume can be roughly estimated using the ideal gas law as:

Mass stored (standard cubic centimeters, scc)=Volume P1(cc)*Pressure P1(atm)*Temp Reference(C)/Temp Current(C)

When it is desired to shut off or reduce the flow through the restrictor, the upstream proportional valve shuts off or reduces flow into the P1 volume and the pressure in the P1 volume reduces as it flow through the restrictor and the P1 pressure bleeds down.

The “Bleed Down” mass, MBD, accordingly can be estimated as:

MBD=Vol P1(cc)*[Press P1@1st Flow−Press P1@2nd Flow] (atm)*Temp Ref(C)/Temp Cur(C)

A problem occurs when the mass needed to bleed is significant relative to the flow rating of the device. The author defines significant when this mass divided by the flow rate through the restrictor at the start of the change to be larger than the expected response time of the device. For a device using a linear restrictor such as a sonic nozzle the bleed down time constant, TC BD, of the bleed down, assuming the upstream proportional valve is completely closed becomes:

Tc_{—}BD(sec)=MBD(scc)/Flow(sccm)*60 sec/1 min

For a flow or pressure control device which is expected to change flow or pressure in 1 second, such as currently expected in the semiconductor equipment industry, a bleed down time constant of 1 second precludes the device from fulfilling expectations. In the author's experience, for a robust control system the bleed down time constant would need to be 20% of the expected response time.

A number of special non-standard algorithms are currently used to partially address the issue when the bleed down time is in the 20% to 100% of the acceptable flow response time.

One current practice in the 20% to 100% situation is to use a variation of the internal set point concept described earlier where the internal set point is set slightly above the possible mass flow bleed off rate. Knowing the flow characteristics of the restrictor it is practical to continuously calculate the possible bleed off rate is based on the current P1, P2 pressures and temperature. Setting the internal set point to this value keeps the proportional valve slightly open and avoids the valve lift off issues while producing a bleed off time approaching the fastest possible.

Another current practice is to immediately control the valve voltage/current to via the “Close” and “Park” the proportional valve feeding gas into the P1 volume until the P1 pressure bleeds down or the current mass flow rate is slightly above the target value. At that time the valve “Jump” and a variation of the “Ramp” algorithms are executed with standard PID control returning once valve lift off is detected.

A variation or combination of the two practices described above may also be used for further refinement. However, when the bleed down time is greater than 100% of the acceptable value it is not possible to meet the “need” without thinking outside of the box. One such novel means and method will be disclosed later after the current practice ideas are discussed.

One such method where a “dump” mechanism is attached to the P1 volume to speed the bleed down times by routing the P1 mass to an alternative route than other through the flow restrictor that that typically supplies the process. One embodiment utilizes a valve located on the P1 volume that is opened when needed to remove the mass while another embodiment involves the continuous bleed off from this volume at a rate sufficient so that the bleed down time is fast (i.e. <20% of the acceptable response time) but not so large as to be punitively wasteful or problematic.

In the standard gas stick in a gas box on a semiconductor tool consists of, in series, at least an incoming gas supply shut off valve, an upstream cycle purge valve, the flow/pressure control device (including a P1 pressure transducer and proportional control valve) and a downstream outlet shut off valve. The functions of the incoming and outgoing shut off valve are considered self-explanatory. The cycle purge valve is located in series and between the incoming supply shut off valve and the flow/pressure control device. The cycle purge valve is closed during normal operation when gas is flowing to process, but is used when the evacuation and replacement of one gas (often dangerous) in the gas stick is desired. At such time the upstream supply valve is closed and the cycle purge valve is opened. During this time the P1 volume is alternately 1st pressurized through the open cycle purge valve with an inert purge gas such as N2 (or Ar) and then evacuated through the open cycle purge valve, via a downstream plumbing (valves and tubing) to a vacuum pump.

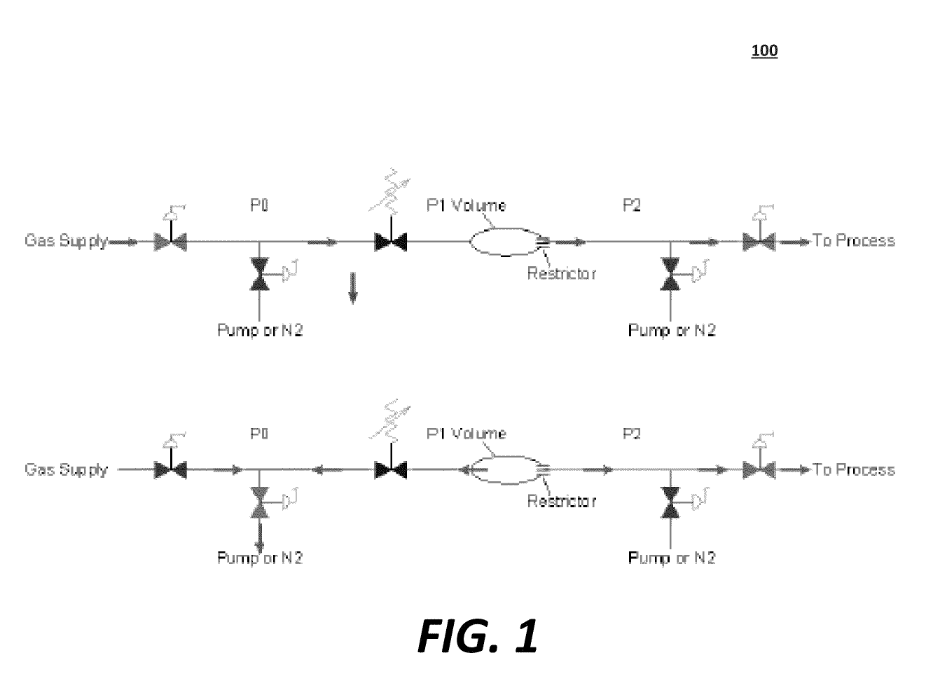

A mechanism and device herein address bleed down without adding hardware only control mechanisms thus reducing the number of components thus reducing cost and size compared to the earlier approaches utilizing “gas dump” hardware described above. FIG. 1 includes diagrams illustrating abstract views of components 100 involved in a forward flow mode and in a reverse flow mode, according to an embodiment.

In an embodiment the existing hardware is used as noted below.
A bleed down time issue can be detected or predicted.
When detected or predicted, the proportional valve and the supply isolation valves are closed.
With the proportional valve and the supply isolation valve closed, the upstream cycle purge valve is opened evacuating the P0 volume between the supply isolation valve and the proportional valve.
The valve control is activated using algorithms similar to the valve “Park”, “Jump”, “Ramp” and a variation of the “Lift off Detect” is used to rapidly drive the valve seat to valve lift off where the gas would begin to flow from the P1 volume to the evacuated P0 volume.
At or prior to that time, the algorithm controlling the proportional valve is changed from (1) a logic that closes the valve (in a PID manner) when the P1 pressure is higher than the target needed to produce the lower flow, to (2) a logic opens the valve (in a PID manner) further when the P1 pressure is higher than the target pressure needed to produce the new flow rate.
With valve lift off achieved and gas beginning to flow from the P1 volume to the P0 volume, the proportional control valve in a PID manner acts as a backpressure controller the exhausts to the evacuated P0 volume. As no gas is flowing into the P1 volume and the flow rate out of the P1 volume to the P0 volume can be readily increased and controlled the P1 volume can quickly be lowered to the target P1 pressure needed for the new flow.
When the P1 pressure approaches the target P1 value needed to stop flow through the restrictor (if a 0% set point is given) or to produce the lower flow rate (if a lower non-zero flow rate is given):
   The upstream cycle purge valve is closed.
   Subsequently, the proportional valve control logic is returned to it former control logic.
   Subsequently, the gas supply valve is opened.
The device resumes normal flow control operation with the P1 pressure having been reduced quickly to the lower P1 value needed for the lower flow and the slow bleed down issue has been addressed.

Generalities of the Disclosure

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

We claim:

1. An electronic regulator to control delivery of a process gas to a semiconductor process at a specific mass flow rate, the electronic regulator using a reverse flow mode for fast bleed down of process gas responsive to a reduction to the specified mass flow rate, the electronic regulator comprising:
a processor; and
a memory, storing:
a controller to determine whether to operate in a forward mode in which process gas flows downstream to an accumulated volume or a reverse mode in which process gas flows upstream out of an accumulated volume,
a communication interface to receive external set points; and
a sensor interface to receive a current reading.
